(19) United States
(12) Patent Application Publication
(10) Pub. No.: US 2026/0187018 A1
(43) Pub. Date: Jul. 2, 2026

(54) MEMORY DEVICE SUPPORTING MULTIPLE SERIAL PRESENCE DETECTION SETTINGS

(71) Applicant: TEAM GROUP INC., New Taipei City (TW)

(72) Inventors: Hsi-Lin Kuo, New Taipei City (TW); Wei-Hsiang Wang, New Taipei City (TW); Chin-Feng Chang, New Taipei City (TW)

(21) Appl. No.: 19/218,932

(22) Filed: May 27, 2025

(30) Foreign Application Priority Data
Dec. 26, 2024 (TW) 113150909

(51) Int. Cl. G06F 13/42; G06F 13/40

(52) U.S. Cl. CPC G06F 13/4282; G06F 13/4068

(57) ABSTRACT

The present application provides a memory device supporting multiple serial presence detection settings. The device includes a sequence presence detection module disposed on a substrate and electrically connected to a plurality of memory units. The sequence presence detection module is electrically connected to a storage element, including a first memory setting data and a second memory setting data respectively support a first processor and a second processor, which are different computational processing circuits. When the sequence presence detection module is electrically connected to a respective processor of the first processor and the second processor, the sequence presence detection module correspondingly reads a respective memory setting of the first memory setting data and the second memory setting data to support the respective processor.

### FIELD OF THE INVENTION

The present application relates to a memory device supporting multiple serial presence detection settings, which can support processors with different computational processing circuits.

### BACKGROUND OF THE INVENTION

Memory typically employs serial presence detection (SPD), and an SPD technology that provides a standardized framework for parameter settings between memory modules and processors. The working principle of the SPD involves Non-volatile Memory (such as EEPROM) built in memory modules to store configuration parameters (such as timing, bandwidth, voltage, etc.). During system startup, the processor reads parameters from the SPD via a Communication Bus (such as Inter-Integrated Circuit (I²C) or System Management Bus (SMBus)) to configure the memory's operating environment, ensuring stable system boot-up.

In current system implementations, the parameter design of SPD technology is typically optimized for the architectural requirements of a single processor manufacturer. For example, the parameter settings within SPD may be specifically tailored for a certain brand of processor to ensure optimal performance on that processor; however, when the memory module is used with processors from other manufacturers, the specifically tailored parameter settings may not match the hardware characteristics of new processor, leading to decreased performance or even incapable of operating properly.

Therefore, these limitations of well-known SPD technology are particularly evident in multi-processor platform applications, failing to meet the needs of modern data centers, cloud computing environments, or other applications that require flexible adaptability.

In light of the issues with the known technologies, the present application proposes a novel operation design based on SPD technology, which pre-stores a plurality of optimized parameter sets for various manufacturers' processor architectures within the SPD, and incorporates a selection mechanism to achieve automatic adaptation.

### SUMMARY OF THE INVENTION

An objective of the present application is to provide a memory device supporting multiple serial presence detection (SPD) settings, wherein a storage component of an SPD module stores a plurality of memory setting data, supporting different processors respectively, and achieves automatic adaptation of the processors upon connection with the processors.

To achieve the aforementioned objective, the present application provides a memory device supporting multiple SPD settings, which is applied for supporting a first processor and a second processor, which are different computational circuits, the memory device comprising a substrate, a plurality of memory units, and an SPD module. The memory units and the SPD module are disposed on the substrate, and the SPD module is electrically connected to the memory units and a storage component. The storage component stores at least a first memory setting data and a second memory setting data. When the SPD module is electrically connected to the first processor, the SPD module reads the first memory setting data to the first processor, and when the SPD module is electrically connected to the second processor, the SPD module reads the second memory setting data to the second processor; thus, the memory device may support different processor architectures.

In an embodiment of the present application, the SPD module further includes a default memory setting data supporting both the first and second processors. When the SPD module is electrically connected to the first processor, the SPD module reads one of the first memory setting data and the default memory setting data to the first processor. When the SPD module is electrically connected to the second processor, the SPD module reads one of the second memory setting data and the default memory setting data to the second processor.

In an embodiment of the present application, the first processor is one of Intel's and AMD's central processing units.

In an embodiment of the present application, the second processor is one of Intel's and AMD's central processing units.

In an embodiment of the present application, the substrate and the memory units match a protocol of DDR5 memory.

### BRIEF DESCRIPTION OF DRAWINGS

FIG. 1A which is a schematic diagram of the memory structure according to an embodiment of the present application.

FIG. 1B to FIG. 1C which are schematic diagrams of the electrical connections according to an embodiment of the present application.

FIG. 2 which is a schematic diagram of the electrical connections according to another embodiment of the present application.

### DETAILED DESCRIPTION OF THE INVENTION

In order to provide the esteemed reviewers with a further understanding and recognition of the features and effects achieved by the present application, a preferred embodiment is presented along with a detailed description as follows:

In view of the problems of the aforementioned prior arts, the present application provides a memory device supporting multiple serial presence detection (SPD) settings, in which the memory device pre-stored optimized setting parameters for various processor architectures within the SPD, and introducing a selection mechanism to achieve the effect of adapting a single memory to different processor architectures, thereby solving the known issues of the prior arts.

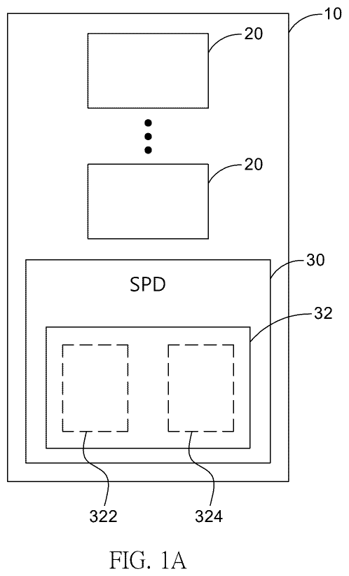

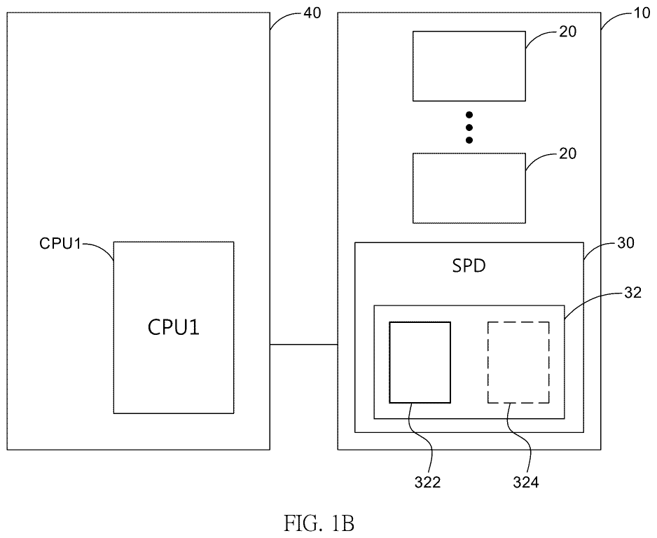

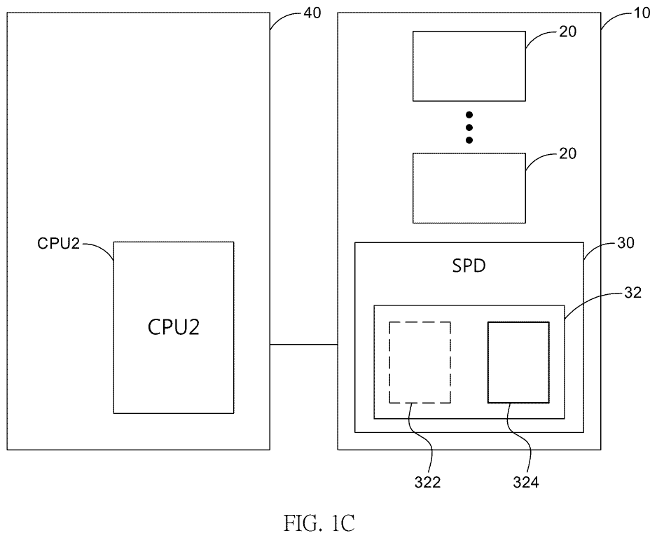

Refer to FIG. 1A, which is a schematic diagram of the memory structure according to an embodiment of the present application. As shown in the figure, this embodiment is the first embodiment, which is a memory device supporting multiple SPD settings, the memory device comprising a substrate 10, a plurality of memory units 20, and an SPD module 30.

Refer again to FIG. 1A and FIG. 1B to FIG. 1C, where FIG. 1B to FIG. 1C illustrate the electrical connection schematic of an embodiment of the invention. As shown in the figures, in this embodiment, the memory units 20 are disposed on the substrate 10, the SPD module 30 is also placed on the substrate 10, and electrically connects to the memory units 20. Additionally, the SPD module 30 is connected to a storage component 32, which stores at least a first memory setting data 322 and a second memory setting data 324. The first and second setting data 322, 324 respectively support a first processor CPU1 and a second processor CPU2, wherein the first memory setting data 322 supports the first processor CPU1, and the second memory setting data 324 supports the second processor CPU2. Both the first processor CPU1 and the second processor CPU2 are different computational processing circuits.

Continued with the above, as shown in the figures, when the SPD module 30 is electrically connected to the first processor CPU1, the SPD module 30 reads the first memory setting data 322 to the first processor CPU1 to match configuration settings of the first processor CPU1. Similarly, when the SPD module 30 is connected to the second processor CPU2, the SPD module 30 reads the second memory setting data 324 to the second processor CPU2 to match configuration settings of the second processor CPU2.

In an embodiment, the first processor CPU1 is disposed on a motherboard 40, and similarly, the second processor CPU2 is disposed on another motherboard 40.

In an embodiment, the first processor is one of Intel's and AMD's central processing units, and similarly, the second processor is one of Intel's and AMD's central processing units. Both the first processor CPU1 and the second processor CPU2 are different computational processing circuits, but are not limited to these.

In an embodiment, the substrate and the memory units match the protocols of DDR5 memory.

The SPD module 30 in this embodiment is executing an SPD of a memory that performs a Power-On Self Test (POST) when the host boots up. This POST process includes setting the timings for the current Central processing unit (CPU) and accessing the memory. The SPD module 30 may, depending on the processor, access BIOS parameters to view and change settings, such as the first memory setting data 322 or the second memory setting data 324, to obtain the optimal memory timing corresponding to different venders' CPUs, including for overclocked memory.

Continued with the above, SPD is a standardized technology used for accessing data about the configuration, capacity, speed, and other relevant information of memory modules. The main purpose of SPD is to enable the host quickly understand the characteristics of memory modules during system startup or operation, thereby correctly configuring and utilizing memory resources. The emergence and development of this technology stem from the increased demands for compatibility and performance of memory modules in modern computing systems.

In early designs of memory module, the method of Parallel Presence Detect (PPD) was used, which provided 5-bit parallel data through five pins in the memory module to convey basic information about the memory module. However, with the development of memory technology, especially the continuous increase in capacity and speed, the mere 5 bits of data have become insufficient to meet the needs for storing more complex module configuration information.

The introduction of SPD technology has resolved this limitation. As SPD replaces parallel detection, the SPD technology utilizes a small Non-volatile Memory (such as EEPROM) to store the detailed parameters of the memory module in a serial data transmission manner. The parameters include module capacity, module clock speed, module delay time, module voltage requirements, and other key configuration data that affect system performance and stability. Upon system startup, the motherboard or memory controller accesses the SPD storage through the I²C (Inter-Integrated Circuit) interface to read the parameters one by one. The serial data transmission manner significantly enhances the storage of more complex configuration information compared to the PPD.

The adoption of SPD not only simplifies the design of memory modules but also significantly improves system abilities to identify and configure memory. In modern systems, BIOS or UEFI reads the SPD information during startup to ensure proper alignment of memory modules with the motherboard and automatically adjusts the clock frequency and delay parameters based on the data provided by the SPD module 30. This adaptive capability not only improves system stability but also eliminates the need for users to manually configure complex memory parameters.

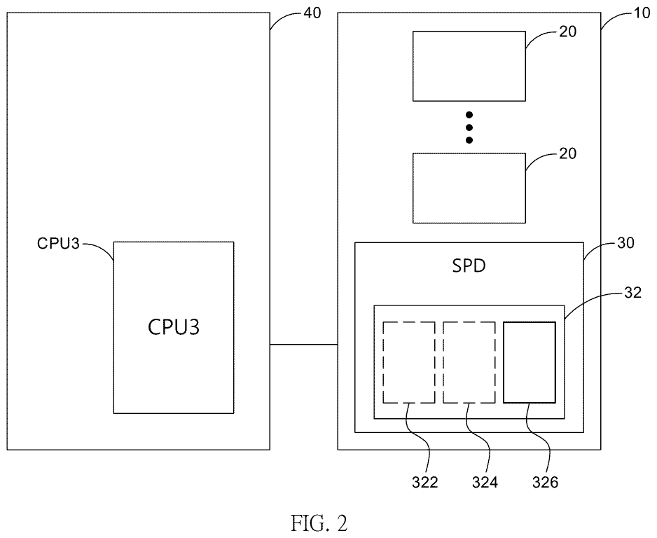

Please refer to FIG. 2, which is a schematic diagram of the electrical connection according to another embodiment of the present application. As shown in the figure, in this embodiment, the SPD module 30 further contains a default memory setting data 326 based on the first embodiment. The default memory setting data 326 supports the first processor CPU1, the second processor CPU2, and another processors CPU3. When the SPD module 30 is electrically connected to the first processor CPU1, the SPD module 30 may read one of the first memory setting data 322 and the default memory setting data 326 to the first processor CPU1. When the SPD module 30 is electrically connected to the second processor CPU2, the SPD module 30 may read one of the second memory setting data 324 and the default memory setting data 326 to the second processor CPU2.

Continued with the above, in this embodiment, when the SPD module 30 electrically connects to the another processor CPU3 that is not supported by the first memory setting data 322 or the second memory setting data 324, the SPD module 30 reads the default memory setting data 326 to the another processor CPU3, for prioritizing operability to adapt to the another processor CPU3.

In summary, the present application proposes a new design based on SPD, which pre-stores multiple sets of optimized parameters for multi-vendor processor architectures within the storage component of the SPD module, and introduces a selection mechanism to achieve automatic adaptation. The present application pre-stores a plurality of parameter sets for different processor vendors and architectures in SPD, and classifies and manages these parameters based on their type and scope of application, ensuring that the memory module can adapt to architectures from multiple processor vendors. Moreover, the SPD module may automatically select the optimized configuration from the pre-stored parameters based on the identification signal provided at processor startup, achieving efficient plug-and-play adaptation and optimized design, ensuring high performance and compatibility of the memory module across multiple platforms.

Continued with the above, the present application further reduces manual intervention, avoiding the tedious process of manually adjusting SPD parameters, significantly lowering deployment and maintenance costs, particularly suitable for large-scale, multi-platform application scenarios. The multiple parameters in the SPD module enable the memory module to be generalized during the design, production, and testing stages, reducing the need for independent design for single vendor architectures, thereby lowering overall costs. Further, the issue of known memory applications to processors from other vendors is overcome while the parameters may not match hardware characteristics of the new processor, leading to performance degradation or even failure to operate normally. The present application significantly reduces the universality and cross-platform compatibility of the memory module, which causes performance impairment and insufficient compatibility issues, as well as the present application solves the problem of increased deployment and maintenance costs due to lack of flexibility.

1. A memory device supporting multiple serial presence detection settings, which is applied for supporting a first processor and a second processor, which are different computational circuits, the memory device comprising:
a substrate;
a plurality of memory units, disposed on the substrate; and
a serial presence detection module, disposed on the substrate and electrically connected to the memory units, which is also connected to a storage component storing at least a first memory setting data and a second memory setting data supporting the first and second processors respectively;
wherein the serial presence detection module reads the first memory setting data to the first processor when the serial presence detection module is electrically connected to the first processor, and the serial presence detection module reads the second memory setting data to the second processor when serial presence detection module is electrically connected to the second processor.

2. The memory device supporting multiple serial presence detection settings of claim 1, wherein the serial presence detection module further includes a default memory setting data supporting both the first and second processors, the serial presence detection module reads one of the first memory setting data and the default memory setting data to the first processor when the serial presence detection module is electrically connected to the first processor, and the serial presence detection module reads one of the second memory setting data and the default memory setting data to the second processor when the serial presence detection module is connected to the second processor.

3. The memory device supporting multiple serial presence detection settings of claim 1, where the first processor is one of Intel's and AMD's central processing units.

4. The memory device supporting multiple serial presence detection settings of claim 1, wherein the second processor is one of Intel's and AMD's central processing units.

5. The memory device supporting multiple serial presence detection settings of claim 1, wherein the substrate and the memory units match a protocol of DDR5 memory.
